(19) United States
(12) Patent Application Publication
(10) Pub. No.: US 2025/0010391 A1
(43) Pub. Date: Jan. 9, 2025

(54) WELDING APPARATUS, ROBOTIC WELDING SYSTEM AND METHOD FOR FEEDING A WIRE ELECTRODE WITH HIGH-PRECISION STICKOUT ADJUSTMENT

(71) Applicant: FRONIUS INTERNATIONAL GMBH, Pettenbach (AT)

(72) Inventors: Manuel Binder, Pettenbach (AT); Andreas Waldhoer, Pettenbach (AT); Christian Stumpfl, Pettenbach (AT)

(21) Appl. No.: 18/710,449

(22) PCT Filed: Apr. 13, 2023
(86) PCT No.: PCT/EP2023/059678

§ 371 Date: May 15, 2024

(30) Foreign Application Priority Data
Apr. 26, 2022 (EP) 22169892.1

(51) Int. Cl. B23K 9/133

(52) U.S. Cl. CPC B23K 9/133

(57) ABSTRACT

The invention provides a welding apparatus and a method for feeding a wire electrode into a position with a defined free wire electrode length from a contact tip of a welding torch of a welding apparatus. Information about a voltage change between the wire electrode on the one hand and a reference electrode on the other hand is used to determine a position of the wire electrode end at the time of the voltage change. The wire electrode can then be moved precisely to the desired position.

### TECHNICAL FIELD

The present invention relates to a welding apparatus with a high-precision stickout setting, a robotic welding system with a high-precision stickout setting and a method for feeding a wire electrode with a high-precision stickout setting. By “stickout”, a free wire electrode length of the wire electrode from a contact tip end of a contact tip of a welding torch of the welding apparatus is meant.

### TECHNICAL BACKGROUND

In many welding apparatus and welding processes, it is necessary to know or provide the free wire electrode length from a contact tip end of a contact tip of a welding torch with high accuracy. If, for example, the welding torch is robot-guided, the position of the robot and therefore of the contact tip end is sometimes known with a high degree of accuracy. An inaccuracy or ignorance of the distance between the wire electrode end and a workpiece is therefore essentially due to the less precisely known free wire electrode length from the contact tip end. The distance between the wire electrode end and the workpiece is in turn important for controlling the welding processes, for example when igniting an arc. It can also be important to know such distances precisely for processes upstream or downstream of the actual welding process. Even if a wire feed, i.e. the feeding of the wire electrode, is continuously monitored by a monitoring device, monitoring errors can accumulate and the free wire electrode length can therefore be set increasingly inaccurately. In addition, a user of the welding apparatus may manually cut off a wire electrode end and thus change the free wire electrode length without this becoming known to the monitoring device.

The free wire electrode length is therefore usually measured using a ruler or gauge, which takes a lot of time and is sometimes not possible, as robotic welding cells, for example, can sometimes be difficult to reach. Often, for example, there is no access to robotic welding cells, or automatic operation or a safety system is provided. In addition, personnel must always be available for this task.

### SUMMARY OF THE INVENTION

It is therefore an objective of the present invention to provide a welding apparatus by means of which the free wire electrode length can be set with particular precision. A further objective is to provide a robotic welding system which comprises such a welding apparatus. A further objective is to provide a method for feeding a wire electrode in a position with a precisely defined free wire electrode from a contact tip of a welding torch of a welding apparatus. A further objective is that the setting of a free wire electrode length is adjustable during manual welding or automatically by a welding system, e.g. a robotic welding system.

These objectives are solved by the subject-matter of the independent patent claims.

Accordingly, a welding apparatus is provided, with:
a feeding device for feeding a (consumable) wire electrode of the welding apparatus;
a wire electrode contact device for electrical contacting of the wire electrode;
a reference electrode which is electrically connected or connectable to a reference potential;
an electrical parameter measuring device, in particular a voltage measuring device, which is configured to measure an electrical parameter, in particular a voltage, between the wire electrode contact device and the reference electrode; and
a control device which is configured to carry out at least one positioning method, wherein in the at least one positioning method the wire electrode is fed by the feeding device into a position with a defined free wire electrode length (“stickout”) from the contact tip end of a contact tip of a welding torch of the welding apparatus, wherein the feeding device is configured, in order to carry out the at least one positioning method:
to determine a current position of a wire electrode end of the wire electrode based on at least one measurement in which a change in the electrical parameter measured by the electrical parameter measuring device is detected while the wire electrode is fed by the feeding device; and
to control the feeding device to feed the wire electrode based on the determined current position until the defined free wire electrode length lies between the wire electrode end and the contact tip end.

Accordingly, one of the basic ideas of the present invention is that an electrical parameter measurement, in particular voltage measurement (more precisely: a detection of a voltage change) or current measurement, is used to determine a current position of the wire electrode end. For this purpose, the wire electrode contact device, which electrically contacts wire electrode, is provided. This allows an electrical parameter, e.g. an electrical voltage, to be measured between the wire electrode and a reference electrode. If the necessarily electrically conductive consumable wire electrode is electrically contacted at defined points within the welding apparatus and thus comes into contact with another electrical potential, a position of the wire electrode can be determined by knowing these positions.

In particular, the wire electrode is a consumable wire electrode.

It is particularly advantageous if the wire electrode runs in an electrically insulating liner and therefore only makes electrical contact with the contact tip when the wire electrode enters the contact tip. Since the contact tip is in any case kept at a defined electrical potential (“welding plus”), so that the welding current flows relative to the potential of the workpiece to be welded (Ground or “welding minus”), it is therefore suitable that the electrical parameter measuring device detects voltage changes or current changes caused by the wire electrode entering into electrical contact with the contact tip. The reference electrode, which is at a defined reference potential, can preferably be connected to Ground or it can be connected or connectable to the contact tip of the welding torch. In this way, welding potentials already existing and provided in the welding apparatus can be used to advantage. However, it is also conceivable that the reference electrode is at a further electrical potential that is different from the welding plus and welding minus.

A positioning method shall be understood in particular as a process by means of which the wire electrode can be brought into a defined position in relation to the welding torch, in particular into a position with a defined free wire electrode length in front of the contact tip end (“stickout”). The positioning method differs in particular from a welding method or welding process, in that no welding current flows and/or no workpiece is worked on or contacted during the positioning method. The positioning method can be carried out from the start of threading the wire electrode into the welding apparatus, for example automatically with the threading of a new wire electrode (also referred to as a welding wire).

However, the positioning method is particularly advantageous when it is carried out between welding processes, so that the free wire electrode length and thus often also the distance between the wire electrode end and the workpiece becomes known again with particular precision. As will also be explained in the following, a particular strength of the inventive idea lies in the fact that dead time between two welding processes can be used to reset the desired free wire electrode length or, in other words, to readjust it. Such a dead time can occur, for example, when a robotic arm of a robotic welding system moves between an end point of a first welding process and a start point of a second welding process. This dead time can therefore also be utilized.

For manual welding, it can be advantageous if a free wire electrode length is automatically set before welding begins so that it tells the welder what the ideal distance between the contact tip and the workpiece should be. This can be set automatically based on the settings of the welding machine regarding the type of welding process, type of workpiece and the like.

In general, it can be provided that an electrical parameter measuring device is configured for measuring an electrical parameter (e.g. voltage or current and electrical variables derived therefrom) between the wire electrode contact device and the reference electrode, and that the current position of the wire electrode end of the wire electrode is determined based on at least one measurement in which an electrical parameter change (e.g. voltage change or current change) of the electrical parameter measured by the electrical parameter measuring device is detected while the wire electrode is being fed by the feeding device. For example, the measured electrical current could initially be 0 mA and increase to a value in the range of 1 mA to 500 mA when electrical contact is made between the wire electrode and the contact tip. The electrical parameter change would therefore be an increase in current.

In the following, mainly a variant in which the electrical parameter measuring device is or comprises a voltage measuring device by means of which a voltage change between the wire electrode (more precisely: wire electrode contact device) and the reference electrode can be measured or is measured will be used as an example to explain the invention. However, it shall be understood that alternatively (or additionally) the electrical parameter measuring device can also be or comprise a current measuring device, as described.

According to some preferred embodiments, variants or further refinements of embodiments, the reference electrode is electrically connected or connectable to ground. The electrical parameter measuring device is or comprises a voltage measuring device which is configured at least for measuring a voltage between the wire electrode and Ground. In particular, the reference electrode can also be electrically connected to the workpiece. Such an arrangement is particularly simple, as it requires hardly any additional elements compared to a conventional welding apparatus.

According to some preferred embodiments, variants or further refinements of embodiments, the reference electrode is electrically connected or connectable to a contact tip of a welding torch of the welding apparatus. The electrical parameter measuring device is or comprises a voltage measuring device, which is at least configured to measure a voltage between the wire electrode and the contact tip. As already explained, the wire electrode usually comes into electrical contact with the contact tip when it enters the contact tip (short circuit).

According to the invention, a change in the electrical parameter, in particular a voltage change or current change, can thus be detected at this time point and it can thus be concluded that the wire electrode end is located at the entrance of the contact tip. Using a known wire electrode feed speed (or wire feed speed for short) by the feeding device and a known distance between the start of the contact tip and the end of the contact tip (contact tip length), the wire electrode end can thus be fed from the known position at the start of the contact tip to the desired end position with the desired defined free wire electrode length in front of the contact tip end.

The length of the contact tip can be known in advance and, for example, can be stored or be storable in the control unit. It is also conceivable that a storage medium or identification code is connected to the contact tip or the welding torch, by means of which the control device can automatically determine the length of the contact tip (contact tip length). In some variants, if the contact tip length is unknown, a user of the welding apparatus can also be prompted to enter the length of the contact tip, for example by means of a display or voice control. The user can then measure the contact tip length, take it from a parts list or determine it in some other way and communicate it to the control device using their input device. The input device can, for example, be a touchscreen of the welding apparatus. If the welding apparatus is equipped with a voice control system, the user can also tell the control unit the contact tip length in natural language or the entire interaction between the control unit and the user can be carried out via input and output of natural language.

According to some preferred embodiments, variants or further refinements of embodiments, the wire electrode contact device has a sliding contact roller and/or a drive roller for the wire electrode. In this way, the wire electrode can be electrically contacted in a simple and controllable manner. Drive rollers in particular are typical components within the feeding device, for example, where good mechanical contact with the wire electrode is necessary anyway, and they can therefore be easily configured for electrical contacting of the wire electrode. However, it is also conceivable that the wire electrode contact device makes electrical contact with the wire electrode via a guide roller pressed against the wire electrode, a sliding contact or at least one ball bearing with conductive lubrication. As it is sufficient to tap the electrical potential, the electrical coupling to the wire electrode does not necessarily have to be low-resistance. For example, the electrical coupling to the wire electrode can have an electrical resistance of up to 100 kiloohms, for example an electrical resistance of between 0.5 kiloohms and 100 kiloohms, or between 10 kiloohms and 50 kiloohms.

According to some preferred embodiments, variants or further refinements of embodiments, the control device has a signal propagation time provision module which is configured to provide a signal delay value (“signal propagation time error”) for components of the control device. The control device can be configured to take the provided signal delay value into account, in particular to compensate for it, when determining the current position of the wire electrode end. The signal propagation time provision module can comprise the signal delay value as a stored quantity or be configured and configured to determine a current signal delay value. The signal delay value can be determined at the request of a user, regularly or automatically according to a predefined trigger. The trigger can, for example, be the result of a plausibility check if it turns out that carrying out the positioning method according to the invention with the currently known signal delay value does not result in the desired accuracy of the free wire electrode length.

It is also conceivable that the control device calculates the current position of the wire electrode end without using the signal delay value, but adjusts the control signals for controlling the feeding device to set the defined free wire electrode length, taking into account the signal delay value from the signal propagation time provision module. In particular, the control device will reduce the wire electrode length still to be fed by a value which is equal to the signal delay value multiplied by a feeding speed of the wire electrode.

According to some preferred embodiments, variants or further refinements of embodiments, the control device is adapted to perform the determination of the current position of the wire electrode end based on a plurality of measurements of changes in electrical parameters (e.g. voltage changes). In particular, two or more of these multiple measurements can be performed at different positions of the wire electrode end, so that each of these measurements provides further information about a current position of the wire electrode.

Alternatively or additionally, two or more measurements of changes in the electrical parameter (or several electrical parameters) can also be taken at different wire electrode feed speed directions, i.e. at least one measurement when the wire electrode is fed forwards towards the contact tip end and at least one measurement when the wire electrode is fed backwards in the direction of the feeding device. Such measurements at different wire electrode feed speed directions can each be taken at the same and/or different positions of the wire electrode (or at the same and/or different contact points of the welding torch, in particular the contact tip). Since the feed speed as well as the start and end of the wire electrode feed and other parameters of the feeding device are preferably known exactly, additional information about the current position and/or the behavior of the wire electrode end can be collected in this way, which can make the positioning method even more accurate.

According to some preferred embodiments, variants or further refinements of embodiments, the at least one positioning method comprises a precision positioning method. The positioning method may consist of the precision positioning method, or may comprise further options in addition to the precision positioning method, for example a simple positioning method. The simple positioning method can differ from the precision positioning method in particular in that the simple positioning method requires less effort (e.g. can be carried out more quickly), but has a lower accuracy of positioning of the wire electrode end compared to the precision positioning method.

The control device can be configured, in a precision positioning method, to:
detect a first change in an electrical parameter (e.g. first voltage change) using the electrical parameter measuring device, while the wire electrode is fed forward at a first speed by the feeding device towards the contact tip;
thereafter control the feeding device to feed the wire electrode backwards at a second speed, at least until a second change in the electrical parameter (e.g. a second voltage change) is detected by means of the electrical parameter measuring device;
thereafter control the feeding device to feed the wire electrode forward at a third speed until a third change in the electrical parameter (e.g. third voltage change) is detected using the electrical parameter measuring device; and
determine the current position of the wire electrode at least based on a measurement in which the third change was detected. Preferably, the third speed is lower than the first speed. By feeding at a lower speed, the feeding and thus also the positioning of the wire electrode can be carried out with greater accuracy. The primary purpose of measuring the first and/or second change in the electrical parameter is to ensure that the wire electrode end only has to be fed as little as possible at the (slower) third speed in order to achieve the defined (i.e. desired) free wire electrode length. It should be understood that the most precise setting of the free wire electrode length would be achieved by always feeding the wire electrode at a particularly low speed, so that any positional inaccuracy of the wire electrode end due to overtravel, slippage and signal delay is kept to a minimum. In contrast to this, however, it is preferable that the positioning method can be carried out as quickly as possible so that it can be carried out within existing dead times or, if necessary, only requires very short additional dead times. In the automotive industry, for example, the aim is to keep the dead time as close to zero as possible.

The control device is particularly preferably configured to feed the wire electrode further forward, at a fourth speed after determining the current position of the wire electrode, until the defined free wire electrode length lies between the wire electrode end and the contact tip end. It is particularly preferable if the feeding of the wire electrode at the third speed transitions steadily and monotonically increasing into feeding at the fourth speed. The fourth speed is preferably greater than the third speed. If the current position of the wire electrode (precisely: the end of the wire electrode) is known exactly when the third change in the electrical parameter is measured, the wire electrode itself can be fed to the position with the defined free wire electrode length at the (increased) fourth speed so that the end position of the wire electrode is reached more quickly and welding can be continued more quickly, for example.

The invention also provides a robotic welding system comprising a welding apparatus according to the invention. The robotic welding system further comprises a robotic device (for example a robotic arm) which is adapted to guide the welding torch of the welding apparatus, and a system control device which is adapted to generate and transmit control signals for controlling the robotic device as well as to generate and transmit control signals for controlling the welding apparatus. The control device of the welding apparatus is advantageously configured to receive, among the control signals, a positioning method trigger signal from the system control device and to carry out one of the at least one positioning method in response thereto. The system control device can be integrated into the welding apparatus, integrated into the robotic device or configured and arranged separately from both the welding apparatus and the robotic device. For example, the system control device can also be implemented by a remotely located server or by a cloud computing platform.

A particular advantage of the system control device is that it has information on when welding starts and when there is a dead time, for example because the robotic device must first be moved or realigned. For example, the system control device can be provided with a welding sequence plan, which the system control device can use to automatically determine how much dead time is necessarily between the end of the previous welding process and the start of the next welding process according to the welding sequence plan.

The system control device may further comprise a database with information about the time durations or the maximum time durations of each positioning method of the at least one positioning method. Based on the known dead time, the system control device can thus advantageously control the control device of the welding apparatus to perform the most precise positioning method feasible within the upcoming dead time. In this way, at least one dead time in a welding schedule with several welding processes (or: welding tasks), preferably several dead times and most preferably all dead times, can be used in the welding schedule to ensure that a known, in particular defined, free wire electrode length is available as often as possible or even always before the start of a welding process.

According to some preferred embodiments, variants or further refinements of embodiments, the at least one positioning method is performed while the robotic device is in transit between two positions at which the welding apparatus is controlled for welding, wherein no welding takes place during the transit. In other words, as already discussed, the positioning method may preferably be performed during a dead time of the welding apparatus, that is during a time when no welding is possible or no welding process is performed, for example because the welding torch is not at the correct distance and/or orientation to a workpiece of the next welding process.

Furthermore, the invention provides a method for feeding a wire electrode in a position with a defined free wire electrode length from a contact tip of a welding torch of a welding apparatus. The method comprises at least the steps of:
defining a desired free wire electrode length of the wire electrode;
measuring an electrical parameter, e.g. a voltage, between the wire electrode and a reference electrode;
feeding the wire electrode in the direction of a contact tip;
determining a current position of the wire electrode, in particular a wire electrode end of the wire electrode, based on a measured change in the measured electrical parameter while the wire electrode is being fed; and
feeding the wire electrode based on the determined current position until the defined free wire electrode length lies between the wire electrode end and the contact tip end.

The definition of the desired free wire electrode length of the wire electrode can be based on a setpoint value for the free wire electrode length stored in a control device of the welding apparatus. Alternatively, the desired free wire electrode length can also be defined depending on a welding process to be carried out, for example by the input of a user via an input device and/or by control signals from a system control device, as described above. It is also conceivable that the free wire electrode length is automatically defined by the control device based on parameters of a welding process to be carried out, for example using a database.

According to some preferred embodiments, variants or further refinements of embodiments, a signal delay value is taken into account when determining the current position of the wire electrode end. In this way, the current position can be determined even more precisely.

According to some preferred embodiments, variants or further refinements of embodiments, the determining of the current position of the wire electrode end is performed based on multiple measurements of changes of an electrical parameter (e.g. voltage changes) as described in the foregoing. When detecting or determining the position of the wire electrode at different contact points, averaging can also be performed by the computing device in order to increase the accuracy of determining the position.

According to some preferred embodiments, variants or further refinements of embodiments, the reference electrode is electrically connected or connectable to ground. The measurement of the electrical parameter, e.g. the voltage, can thus be carried out in particular between the wire electrode and Ground.

According to some preferred embodiments, variants or further refinements of embodiments, the reference electrode is electrically connected or connectable to a contact tip of the welding torch of the welding apparatus. The measuring of the electrical parameter, e.g. the voltage, can be carried out in particular between the wire electrode and the contact tip, more specifically between an electrical potential of the wire electrode and an electrical potential of the contact tip.

According to some preferred embodiments, variants or further refinements of embodiments, the method according to the invention further comprises the steps of:
detecting a first change in the electrical parameter (e.g. first voltage change) while the wire electrode is fed forward towards the contact tip at a first speed;
feeding the wire electrode backwards at a second speed at least until a second change in the electrical parameter (e.g. second voltage change) is detected;
advancing the wire electrode at a third speed at least until a third change in the electrical parameter (e.g. third voltage change) is detected; and
determining the current position of the wire electrode end at least based on a measurement with which the third change was detected.

The third speed is preferably lower than the first speed. A method with the aforementioned additional method steps can also be referred to as a precision positioning method and can be one of several positioning methods, which is carried out as the method according to the invention or as part of the method according to the invention. The first change in the electrical parameter, the second change in the electrical parameter and the third change in the electrical parameter are detected in particular in this order.

In some preferred embodiments, variants or further refinements of embodiments, after the current position of the wire electrode end has been determined, the wire electrode is fed forward at a fourth speed until the defined free wire electrode length lies between the wire electrode end and the contact tip end. The fourth speed is preferably greater than the third speed. It is particularly preferable for the third speed to merge continuously and monotonically into the fourth speed.

Further preferred embodiments, variants and further refinements of embodiments are shown in the dependent claims and in the description with reference to the figures.

### BRIEF DESCRIPTION OF THE FIGURES

The invention is explained in more detail below with reference to embodiments in the figures in the drawings. The partially schematic illustrations show:

FIG. 1a a schematic diagram illustrating a welding apparatus according to an embodiment of the present invention;

FIG. 2 a) to d) position and movement states of a wire electrode at different times when carrying out a simple positioning method;

FIG. 3a) a sequence diagram of a position of the wire electrode in the simple positioning method;

FIG. 3b) a sequence diagram of the speed of the wire electrode during the simple positioning method;

FIG. 3c) a sequence diagram of a voltage difference between the wire electrode and a reference electrode in the simple positioning method;

FIG. 4a) to g) position and movement states of a wire electrode at different times when performing a precision positioning method;

FIG. 5a) a sequence diagram of a position of the wire electrode in the precision positioning method;

FIG. 5b) a sequence diagram of a speed of the wire electrode in the precision positioning method;

FIG. 5c) a sequence diagram of a voltage difference between the wire electrode and a reference electrode in the precision positioning method;

FIG. 6a a schematic representation for explaining a welding apparatus according to a further embodiment of the present invention;

FIG. 7 a schematic block diagram of a robotic welding system according to still another embodiment of the present invention; and

FIG. 8a a schematic flow chart explaining a method according to still another embodiment of the present invention.

In all figures, identical or functionally identical elements and devices have been given the same reference signs, unless otherwise indicated. The designation and numbering of the process steps does not necessarily imply a sequence, but serves the purpose of better differentiation, although in some variants the sequence can also correspond to the sequence of the numbering.

### DETAILED DESCRIPTION

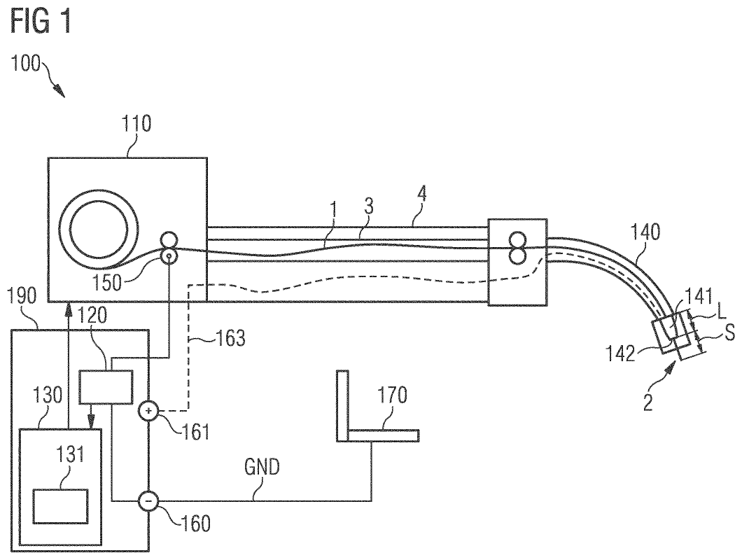

FIG. 1 shows a schematic diagram illustrating a welding apparatus 100 according to an embodiment of the present invention. The welding apparatus 100 has a feeding device 110 for feeding a consumable wire electrode 1 of the welding apparatus 100. The wire electrode 1 can be fed, for example, with the aid of a drive roller and one or more guide rollers.

The welding apparatus 100 also has a welding torch 140, which ends in a contact tip 141. The contact tip 141 has a contact tip length L between its start at the pipe bend of the welding torch 140 and the contact tip end 142. For welding, the wire electrode 1 is usually fed to a defined free wire electrode length S from the contact tip end 142. During a welding process, it is of great advantage to know the free wire electrode length S as precisely as possible, especially if the distance of the contact tip end 142 from a workpiece 170 to be welded is known. In this way, the distance between the wire electrode end 2 and the workpiece 170 is also known. The known distance can also be used for other applications upstream or downstream of the actual welding, such as scanning a workpiece with the wire electrode end 2 for sensing, marking or the like.

FIG. 1 also shows that the welding apparatus 100 has a welding power source 190, which is configured to provide electrical power, in particular welding power for welding, for the welding apparatus 100. The welding power source 190 and the feeding device 110 can be arranged in different housings, as shown schematically in FIG. 1, can be integrated in one and the same housing and/or the like. The feeding device 110 can also be arranged completely in a separate housing or, for example in the case of a push-pull feeding device, can be arranged partially close to or in the welding power source 190 and partially close to or in the welding torch 140, so that the wire electrode 1 is partially pushed forward (“push”) and partially pulled (“pull”).

The welding apparatus 100 also has a wire electrode contact device 150, by means of which the wire electrode 1 can be and is electrically contacted. FIG. 1 shows the case in which the wire electrode contact device 150 contacts the wire electrode 1 by means of a drive roller. In order to ensure that the wire electrode 1 is fed reliably, it is usually already provided that such a drive roller is always in firm contact with the wire electrode 1. For this reason, it is convenient to also use this drive roller to make electrical contact with the wire electrode 1. Alternatively, the potential of the wire electrode 1 could also be tapped at a push-pull unit. In some embodiments, it may be provided that a rotor shaft of an electric motor is at the electrical potential of the wire electrode 1, for example because the drive roller and clamping adapter are not electrically insulating. In this case, the potential of the wire electrode 1 can therefore also be tapped at the rotor shaft.

The welding apparatus 100 also has a reference electrode 160, which is electrically connected to a reference potential. In the example shown in FIG. 1, the reference electrode 160 is connected to ground GND or, in other words, to the welding negative pole, which is also connected to the workpiece 170. The welding power source 190 is configured and configured to provide an electrical voltage, the welding voltage, between the contact tip 141 and the workpiece 170. For this purpose, the welding power source 190 has a positive electrode 161 which, as shown again schematically in FIG. 1, is electrically connected to the contact tip 141 via an electrical line 163.

Between the feeding device 110 and/or welding torch 140, the wire electrode 1 normally runs at least partially within a liner 3, which in the present case is electrically insulating. Alternatively, the liner can also be electrically conductive, in which case, however, electrical insulation must be provided between the liner 3 and the contact tip 141 as well as the welding potential. The liner 3 usually runs within a cable bundle 4. The electrical lines 163 can also run completely or partially within the cable bundle 4, as is also shown schematically in FIG. 1.

When, pushed forward by the feeding device 110, the wire electrode 1 finally enters the contact tip 141 from the pipe bend of the welding torch 140, the wire electrode 1 contacts the contact tip there in an electrically conductive manner and is thereby brought to the same potential. Since the location (or: contact point) at which this occurs, namely the start of the contact tip 141, is known, information about a change in an electrical parameter, e.g. a change in current or voltage, at the wire electrode 1 can be used according to the invention to determine that the wire electrode end 2 is currently at the said position, i.e. at the contact point of the contact tip 141.

In the embodiment shown in FIG. 1, a voltage measuring device 120 is provided as an electrical parameter measuring device, which is configured to measure a voltage between the wire electrode contact device 150 (and thus the wire electrode 1 itself) on the one hand and the reference electrode 160 (here to ground GND) on the other hand. As shown in FIG. 1, the voltage measuring device 120 can be part of the welding power source 190, but it can also be arranged in another housing of the welding apparatus 100, for example in the feeding device 110 or in yet another separate housing.

Furthermore, the welding apparatus 100 has a control device 130, which is configured to carry out at least one positioning method. The control device 130 can also be integrated into the welding power source 190, integrated into the feeding device 110 and/or integrated into another housing of the welding apparatus 100.

The control device 130 may include conventional computing units, such as a microprocessor, a central processing unit, CPU, a graphics processing unit, GPU, an application specific integrated circuit, ASIC, a field programmable logic gate, FPGA, and/or the like. Further, the control device 130 may include a non-volatile data storage device, for example a hard disk or a magnetic storage device such as a solid-state drive (SSD). The control device 130 may also have a random-access memory (RAM). The control device 130 may also be implemented in whole or in part by a cloud computing platform and/or a remotely connected server. For this purpose, the feeding device 110 and/or the welding power source 190 may have a corresponding interface, for example an Ethernet interface, which may be wired or wireless (WiFi), a radio interface and/or the like.

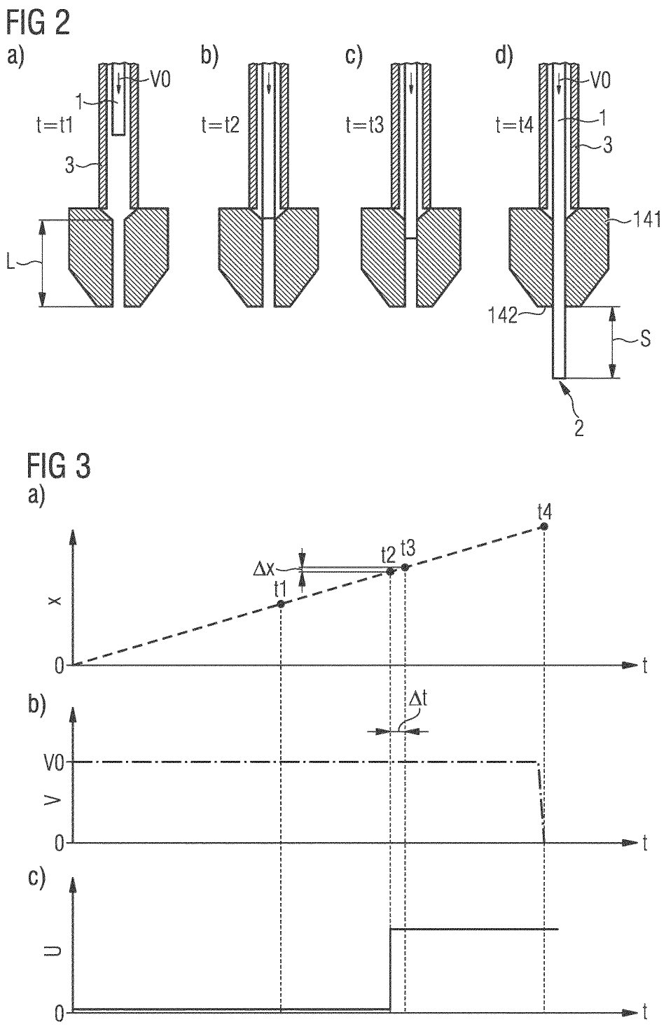

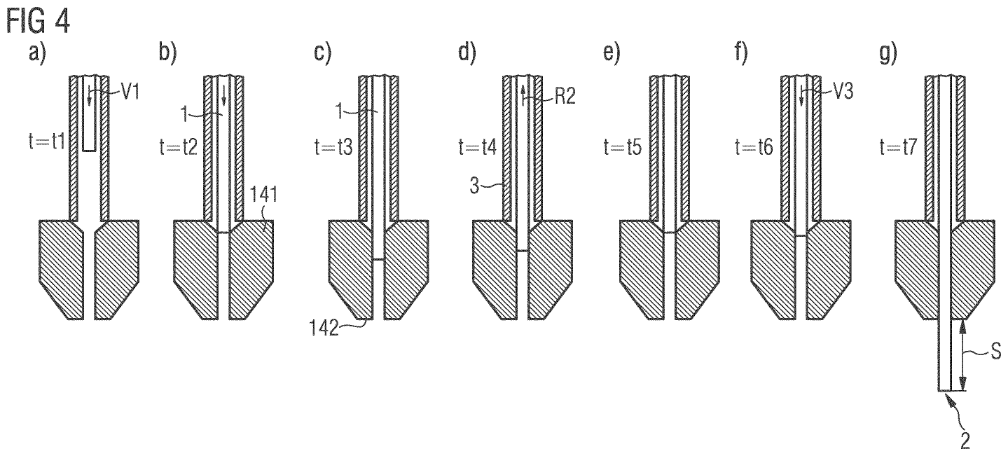

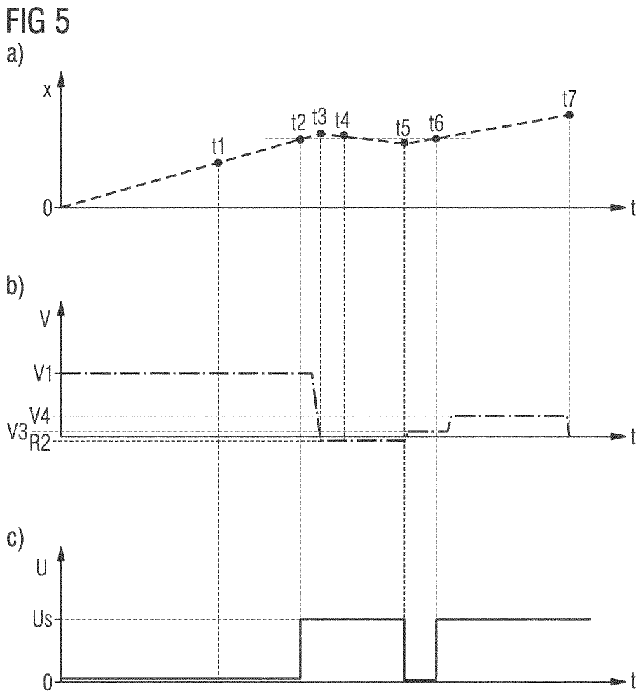

Two different positioning methods are described below, according to which the wire electrode 1 can be fed to a position with a defined free wire electrode length S from the contact tip end 142 in accordance with the invention. First, a simple positioning method (“simple positioning method”) is described with reference to FIG. 2 and FIG. 3. Then a precision positioning method is described with reference to FIG. 4 and FIG. 5. One and the same welding apparatus 100 can be configured and configured in such a way that it can perform both a simple positioning method and/or a precision positioning method or also other positioning methods, between which, for example, a user can freely choose.

As described above, it is also possible for a higher-level control instance, for example a so-called system control device, to select one of the positioning methods available on the welding apparatus 100. This can be done, for example, depending on an available time period, so that in particular the most precise positioning method that can be carried out in the available time period can be performed.

The basic consideration of the simple positioning method is shown in FIG. 2. Subfigures a) to d) of FIG. 2 show different time points t=t1, t=t2, t=t3, t=t4, where t1<t2<t3<t4 applies. Subfigures a) to d) of FIG. 2 each show the wire electrode 1 as it moves forward at a feeding speed V0, i.e. in the direction of the contact tip end 142, initially only within the liner 3, then later partially within the contact tip 141 and finally (t=t4) beyond it, so that a free wire electrode length S (“stickout”) is created.

FIG. 2a), at the point time t=t1, shows how the wire electrode 1 moves forward at the feeding speed V0 within the liner 3 in the direction of the contact tip end 142.

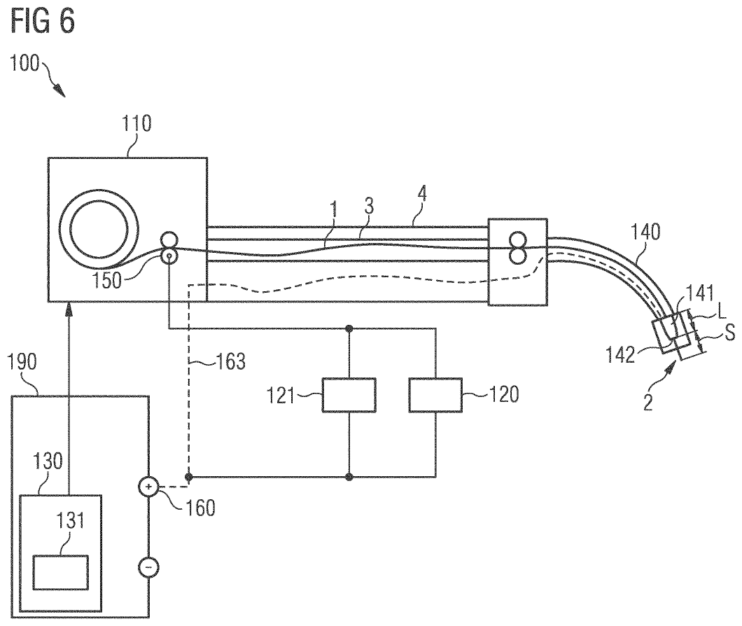

FIG. 3 shows in sub-figures a) to c) a characteristic curve for explaining the positioning method from FIG. 2, whereby the time points t1, t2, t3 and t4 are also shown in each case. FIG. 3a) shows a wire position x as a function of time t, whereby the wire position x is shown from any zero point within the liner. FIG. 3b) shows a feeding speed at which the wire electrode 1 is moved through the feeding device 110 as a function of time t. FIG. 3c) finally shows a voltage U measured by the voltage measuring device 120 between the wire electrode 1 and the reference electrode 160 as a function of the time t. In the case shown in FIG. 1, the reference electrode 160 is connected to ground GND. It is understood that other reference electrodes 160 can also be used, as has already been described above and as will also be explained below with reference to FIG. 6.

As can be seen from the comparison of FIG. 2 and FIG. 3, the wire electrode 1 moves forward at time t1 with a constant speed V0 and thus a linear increase in the wire position x, while the voltage U remains at zero. At time t2, the wire electrode 1 touches the electrical contact tip 141 for the first time, which is at the positive potential of the welding power source 190 (welding plus). This electrical potential is therefore also directly applied to the wire electrode 1, which can be seen in FIG. 3c) by the sudden increase in the voltage level at time t2. Theoretically, the position of the wire electrode 1 is already known at this time. The control device 130 can therefore determine, using the known contact tip length L, that in order to provide the desired free wire electrode length S, the wire electrode 1 must still be fed by exactly the length L+S from the time point t=t2. In a simple case, the control device 130 can now be configured to transmit corresponding instructions in corresponding control signals to the feeding device 110.

However, as also shown in FIG. 3, due to a signal delay Δt, the control device 130 may only become aware of the voltage increase measured by the voltage measuring device 120 at time t2 at time t3, t3=t2+Δt. This signal delay Δt therefore means that the control command to feed the wire electrode 1 forward by L+S, for example, is not actually issued until time t3, as shown in FIG. 2c), at which point the wire electrode 1 has already advanced a distance Δx into the contact tip 141.

Said signal delay Δt between the measurement of the voltage change at t2 and the processing by the control device 130 can also be extended to include consideration of the signal delay with which the control commands actually arrive at the feeding device 110. It is evident that said signal delays cause a (small, but nevertheless undesirable) deviation of the actual free wire electrode length S from the desired and defined setpoint value. The control device 130 can therefore be configured to consider said signal delay and to take it into account, in particular to compensate for it, when generating the control signals, in particular when calculating the wire electrode length still to be fed. As already explained in the foregoing, a signal delay value, which indicates the signal delay, can be provided by a signal propagation time provision module 131 of the control device 130.

The more precisely the signal delay value Δt is predetermined or even determined dynamically or regularly, the more precisely the signal delay can be compensated for and thus the defined and desired setpoint value for the free wire electrode length S can be achieved as accurately as possible.

In the following, a precision positioning method will be described with reference to FIG. 4 and FIG. 5, which can, as an example, also be carried out by the welding apparatus 100 according to FIG. 1, either alternatively to, or as an optional alternative to, the simple positioning method according to FIG. 2 and FIG. 3.

FIG. 4 with subfigures a) to g) schematically depicts the same situation as FIG. 2, namely the respective position of the wire electrode 1, which is fed from the liner 3 in the direction of the contact tip 141 and how the precision positioning method takes place. FIGS. 5a) to c) show the same graphs in relation to the precision positioning method as FIGS. 3a) to c) do in relation to the simple positioning method.

The basic consideration behind the precision positioning method is that the positioning error of the wire electrode 1 in the simple positioning method scales essentially linearly with the speed V0 of the wire electrode 1. While a particularly high speed V of the wire electrode 1 is preferred for positioning the wire electrode 1 so that the positioning method can be carried out and completed as quickly as possible, it would be advantageous for particularly precise positioning if, on the contrary, the feed speed V were particularly low in order to further reduce the positioning error Δx due to the signal propagation time error (signal delay Δt). The method described above for compensating for this error using the signal delay value can of course be used in addition.

The idea behind the precision positioning method is therefore that in a first, rough step, which is carried out at a relatively high, positive first feeding speed V1, the position of the wire electrode, in particular the wire electrode end 2, is roughly determined. This in turn is done by measuring a voltage change by means of the voltage measuring device 120 between the wire electrode 1 and the reference electrode 160. This is shown in FIGS. 4a) and 4b) as well as the time points t=t1 and t=t2, which are analogous to the processes in FIG. 2a) and FIG. 2b).

Thereupon, again with a certain signal delay, the control device 130 instructs the feeding device 110 to stop the wire electrode 1 and feed it backwards at a second speed R2. The backward movement begins at time point t=t3 and continues during time point t=t4. Since the wire electrode 1 is still in electrical contact with the contact tip 141, the voltage U measured by the voltage measuring device 120 remains different from zero, while the wire position x slowly decreases. This continues until, at a time point t5 as shown in FIG. 4e), the wire electrode 1 just becomes electrically detached from the contact tip 141 again, which in turn results in a voltage drop of the voltage U to zero, as can be seen in FIG. 5c) at time point t5.

The retraction with the second, negative speed R2 serves to reposition the wire electrode 1 as precisely as possible shortly in front of the contact point with the contact tip 141, so that the steps already known from the simple positioning method can be carried out again, but with increased precision. It is therefore preferable that the second velocity R2, which is negative, is selected to be smaller in magnitude than the first velocity V1, which is positive, in particular to be less than 50%, particularly preferably less than 10%, particularly preferably less than 5% of the magnitude of the first velocity V1.

At time t5, the feeding device 110 is again instructed by the control device 130 to feed the wire electrode 1 forward, namely at a third speed V3, which is positive and smaller in magnitude than the first speed V1. The third speed V3 can be equal to or even less than the second speed R2.

For example, the first speed V1 can be up to 150 m/min, the second speed R2 up to 100 m/min and/or the third speed V3 up to 75 m/min.

From time t5 onwards, the same procedure is carried out in principle as with the simple positioning method, with the difference that the start speed is now not the original forward feeding speed V1 (or V0 in FIG. 2 and FIG. 3), but the lower speed V3. The corresponding signal propagation time error, which is of course also present when feeding at the second speed R2 and feeding at the third speed V3, can therefore in principle be neglected and is not shown in any detail in FIG. 5. In principle, however, as already mentioned, it is also possible to take additional signal propagation time differences into account in the precision positioning method by the signal propagation time provision module 131 providing a corresponding signal delay value, which the control device 130 then compensates for.

At time point t6, electrical contact is again established between the wire electrode 1 and the contact tip 141, so that the voltage U again increases to the non-vanishing value Us. Due to the low speed V3, the current position of the wire electrode end 2 is therefore known very precisely to the control device 130. The control device 130 can therefore transmit corresponding control signals to the feeding device 110 in order to feed the wire electrode 1 further forward until the desired free wire electrode length S is set.

As shown in FIG. 5b), this can initially continue at the third (forward) speed V3. This speed can be maintained until the end of the precision positioning method. Alternatively, as shown in FIG. 4b), the final adjustment can be carried out at a fourth positive speed V4 in order to complete the precision positioning method even faster. The fourth speed V4 is therefore preferably greater than the third speed V3.

The third speed V3 can particularly preferably transition to the fourth speed V4 in a continuous and monotonically increasing manner. The fourth speed V4 can be selected such that any inaccuracies in the acceleration and deceleration of the wire electrode 1 are of the same order of magnitude as the signal delay error. Therefore, the more precisely the wire electrode 1 can be accelerated and decelerated by the feeding device 110, the higher the fourth speed V4 can be selected, for example up to V4=V1.

FIG. 6 shows a schematic representation of a further possible embodiment of the present invention. In the embodiment shown in FIG. 6, there is a difference in that the voltage measuring device 120 is not configured to measure a voltage between the wire electrode 1 and ground GND. Instead, the voltage measuring device 120 is connected in parallel with a measuring voltage source 121 and in series between the wire electrode 1 (via the wire electrode contact device 150) and a reference electrode 160. The reference electrode 160 is connected here to the electrical potential of the positive electrode 161 of the welding power source 190. The measuring voltage source 121 can be installed or integrated in the power source 190, but can also be arranged externally or connected externally. Since a measurement is not constantly necessary (in particular not during the welding process), the measuring voltage source 121 can be configured to be switched on and off. For example, it can be provided that the measuring voltage source 121 is switched off during a welding process (preferably automatically) and switched on again automatically at the end of the welding process (in particular if repositioning of a welding robot is to take place afterwards).

As long as the wire electrode 1 is not in electrical contact with the contact tip 141, the voltage measuring device 120 will measure the measuring voltage (or: auxiliary voltage) output by the measuring voltage source 121. Suitable values for this measurement voltage are between 3V volts and 60V volts. As soon as an electrical contact is made between wire electrode 1 and contact tip 141, a short circuit occurs instead and is detected by the voltage measuring device 120.

In this embodiment, a voltage drop to zero (short circuit) can therefore be used to detect the position of the wire electrode end 2. Accordingly, the simple positioning method according to FIG. 2 and FIG. 3 and the precision positioning method according to FIG. 4 and FIG. 5 can also be used analogously in the embodiment according to FIG. 6.

Instead of a voltage measuring device 120, a current measuring device could also be used in the variant shown in FIG. 6. Accordingly, instead of a voltage change, a current change could also be measured, in this case an increase in current as soon as the wire electrode 1 touches the contact tip 141.

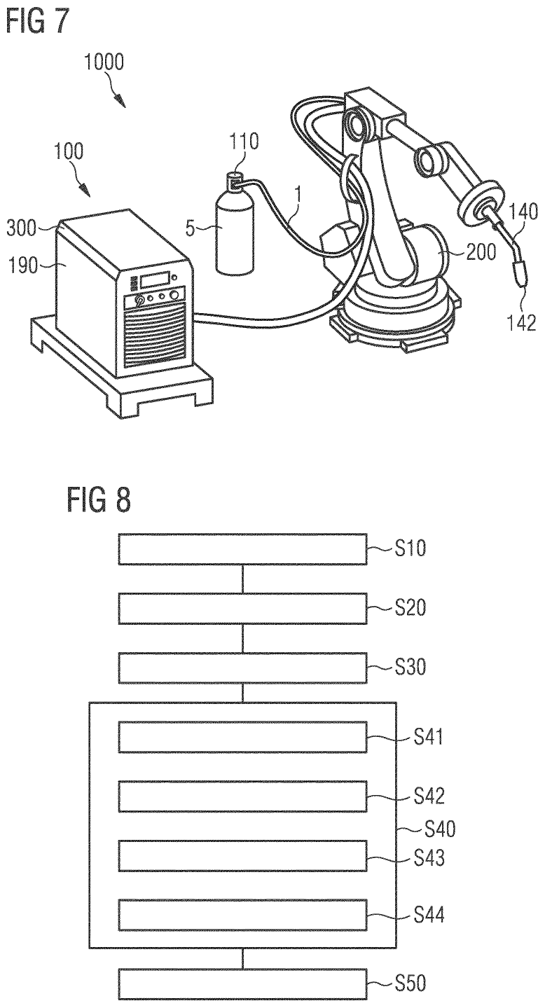

FIG. 7 shows a schematic block diagram of a robotic welding system 1000 according to still another embodiment of the present invention.

The robotic welding system 1000 comprises a welding apparatus 100 according to an embodiment of the present invention, in particular as described in the preceding FIGS. 1 to 6. The robotic welding system 1000 further comprises a robotic device 200, which is configured to guide the welding torch 140 of the welding apparatus 100. In the present example, the robotic device 200 is designed as an approximately man-sized robotic arm. The feeding device 110 of the welding apparatus 100 is arranged, for example, on a barrel as a wire dispenser 5 and takes the wire electrode 1 out of it for feeding.

The robotic welding system 1000 also has a system control device 300, which is configured to generate and transmit control signals for controlling the robotic device 200 as well as to generate and transmit control signals for controlling the control device 130 of the welding apparatus 100. As shown in FIG. 7, the system control device 300 can be integrated into a housing of the welding power source 190 of the welding apparatus 100 and can, for example, also be integrated into the control device 130 of the welding apparatus 100. Alternatively, the system control device 300 may also be integrated into the robotic device 200 or be formed separately, for example by an additional computing device such as a cloud computing platform.

The control device 130 of the welding apparatus 100 is configured to receive, among (i.e.: together with) the control signals from the system control device 300, a positioning method trigger signal from the system control device 300, in response to which the control device 130 performs one of the at least one positioning method.

Advantageously, the positioning method is carried out while the robotic device 200 is in transit between two positions at which the welding apparatus 100 is controlled for welding, with no welding taking place during the transit. The positioning method is thus preferably carried out in a dead time of a welding sequence plan, and in particular with such a positioning method which utilizes the dead time available according to the welding sequence plan in order to obtain the maximum precision when setting the stickout.

FIG. 8 shows a schematic flow chart for explaining a method according to still another embodiment of the present invention. The method explained according to FIG. 7 can be carried out in particular with a welding apparatus or a robotic welding system according to one embodiment of the present invention, in particular according to a welding apparatus 100 or a robotic welding system 1000 as described in one of FIGS. 1 to 8. The method is therefore adaptable according to any described option, variant or further development of the embodiments of the welding apparatus according to the invention and/or the robotic welding system according to the invention and vice versa.

In a step S10, a desired free wire electrode length S of the wire electrode 1 is defined, for example by a parameter output of a welding sequence plan, a user input, a pre-setting and/or the like.

In a step S20, a voltage between the wire electrode 1 and a reference electrode 160 is measured, in particular continuously monitored. As described above, the reference electrode 160 can, for example, be connected to ground GND or to the welding negative, the welding positive or to another defined potential value. The decisive factor is that a voltage change in the measured or monitored voltage can be detected when the wire electrode 1 comes into contact with an electrical contact point, whereby the distance along the path of the wire electrode 1 between the contact point and the contact tip end 142 is known.

In a step S30, the wire electrode 1 is fed in the direction of a contact tip 141, more precisely: in the direction of the contact tip end 142. If the wire electrode end 2 is already inserted into the contact tip 141, this can be determined by the measured voltage. The wire electrode end 2 can then first be retracted by means of the feeding device 110 until it is again outside the contact tip 141 before the further steps are carried out, similar to the precision positioning method described above.

In a step S40, a current position of the wire electrode end 2 of the wire electrode 1 is determined based on a measured voltage change of the measured voltage while the wire electrode 1 is being fed, in particular a voltage change from zero to the reference potential of the reference electrode 160 or from the reference potential to zero.

In a step S50, the wire electrode 1 is fed based on the determined current position until the defined free wire electrode length S lies between the wire electrode end 2 and the contact tip end 142.

The detection S40 of the current position of the wire electrode end 2 can be carried out in particular according to the simple positioning method described above and/or according to the precision positioning method described above.

The precision positioning method can be carried out in particular as explained with reference to FIG. 4 and FIG. 5 and can comprise the following steps:

In a step S41, a first voltage change is detected (e.g. from Us to 0 in FIG. 5c) at time point t2), while the wire electrode 1 is fed forward at a first speed V1 towards the contact tip end 142.

In a step S42, the wire electrode 1 is fed backwards at a second speed R2 at least until (advantageously slightly beyond) a second voltage change is detected (e.g. from 0 to Us in FIG. 5c) at time point t5).

In a step S43, the wire electrode 1 is fed forward at a third speed V3 at least until a third voltage change is detected (e.g. from 0 to Us as in FIG. 5c) at time point t6).

The determination S40 of the current position of the wire electrode end 2 is based at least on a measurement with which the third voltage change was detected,
wherein the third velocity V3 is preferably lower than the first velocity V1 (V3<V1). In particular, the time t6 of the third voltage change can be associated with the position of the wire electrode end 2 at a defined electrical contact point (e.g. start of the contact tip 141). Together with information about a distance from the contact point to the desired position of the wire electrode end 2 (e.g. contact tip length L plus stickout S), it is thus possible to determine in a step S44 how far the wire electrode 1 is or was still to be fed after the time t6. In step S50, the corresponding feeding can then be carried out by the feeding device 110, for example at a fourth speed V4, wherein preferably:

V4>V3

V4<V1 or V4=V1, and/or

|V4|>|R2| applies.

In connection with a robotic welding system 1000, for example as described in connection with FIG. 7, the method may optionally comprise further steps. For example, in a step S60, information about an upcoming dead time of the welding apparatus 100 may be received. In a step S70, based on the upcoming dead time (e.g. when moving the robotic device 200 to start the next welding process), a positioning method can be selected, which is then performed, such as the simple positioning method and/or the precision positioning method. The selection is preferably made according to the criterion that the most precise positioning method should be selected, which can be carried out completely within the dead time.

In variants of the process, however, it can also be determined that a positioning method should always be carried out between two welding processes and that the dead time (i.e. the welding-free time) is extended in order to ensure that a desired positioning method can be carried out completely.

In the preceding detailed description, various features have been summarized in one or more examples to improve the stringency of the presentation. However, it should be understood that the above description is merely illustrative and in no way limiting. It is intended to cover all alternatives, modifications and equivalents of the various features and embodiments. Many other examples will be immediately and directly obvious to a person skilled in the art in view of the above description.

The embodiments have been selected and described in order to best illustrate the principles underlying the invention and its possible applications in practice. This enables those skilled in the art to optimally modify and utilize the invention and its various embodiments with respect to the intended use. It is further understood that units described as separate may be partially integrated with one another.

The idea of the invention can be described as follows: The invention provides a welding apparatus 100 as well as a method for feeding a wire electrode 1 to a position with a defined free wire electrode length S from a contact tip 141 (in particular contact tip end 142) of a welding torch 140 of a welding apparatus 100. Information about a voltage change between the wire electrode 1 on the one hand and a reference electrode 160 on the other hand is used to determine a position of the wire electrode end 2 at the time of the voltage change. The wire electrode can then be fed precisely to the desired position.

### LIST OF REFERENCE SIGNS

1 wire electrode
2 wire electrode end
3 liner
4 cable bundle
5 wire dispenser
100 Welding apparatus
110 feeding device
120 voltage measuring device
121 measuring voltage source
130 control unit
140 welding torch
141 contact pipe
142 contact tip ends
160 reference electrode
161 electrode
163 cables
170 workpiece
190 welding power source
200 robotic device
300 system control device
1000 robotic welding system
L contact tip length
S free wire electrode length in front of the contact tip
S10 . . . . S50 method steps
t1 . . . t6 time points

1. A welding apparatus, with:
a feeding device for feeding a wire electrode of the welding apparatus;
a wire electrode contact device for electrically contacting the wire electrode;
a reference electrode which is electrically connected or connectable to a reference potential;
an electrical parameter measuring device which is configured to measure an electrical parameter between the wire electrode contact device and the reference electrode;
a welding torch with a contact tip which is electrically connected or connectable to a defined electrical potential; and
a control device which is configured to carry out at least one positioning method, in which at least one positioning method the wire electrode is fed by the feeding device into a position with a defined free wire electrode length from a contact tip end of the contact tip, wherein the control device is configured, in order to carry out the at least one positioning method:
to determine a current position of a wire electrode end of the wire electrode based on at least one measurement in which a change in the electrical parameter measured by the electrical parameter measuring device is detected at an electrical contact between the wire electrode end and the contact tip while the wire electrode is fed by the feeding device while the contact tip is connected to the defined electrical potential and the reference electrode is connected to the reference potential; and
to control the feeding device using a known contact tip length of the contact tip to feed the wire electrode based on the determined current position until the defined free wire electrode length lies between the wire electrode end and the contact tip end.

2. The welding apparatus according to claim 1, wherein the reference electrode is electrically connected or connectable to ground, and the electrical parameter measuring device comprises a voltage measuring device which is configured at least for measuring a voltage between the wire electrode and ground when the reference electrode is electrically connected to ground.

3. The welding apparatus according to claim 1, wherein the reference electrode is electrically connected or connectable to a contact tip of a welding torch of the welding apparatus, and the electrical parameter measuring device comprises a voltage measuring device which is configured at least for measuring a voltage between the wire electrode and the contact tip when the reference electrode is electrically connected to the contact tip.

4. The welding apparatus according to claim 1, wherein the wire electrode contact device has a sliding contact and/or a drive roller for the wire electrode.

5. The welding apparatus according to claim 1, wherein the control device has a signal propagation time provision module which is configured to provide a signal delay value for components of the control device, wherein the control device is configured to take the provided signal delay value into account when determining the current position of the wire electrode end.

6. The welding apparatus according to claim 1, wherein the control device is configured to perform the determining of the current position of the wire electrode end based on a plurality of measurements of changes in the electrical parameter.

7. The welding apparatus according to claim 1, wherein the at least one positioning method comprises a precision positioning method, and the control device is configured to, in the precision positioning method:
detect a first change in the electrical parameter while the wire electrode is fed forward at a first speed by the feeding device towards the contact tip using the electrical parameter measuring device;
thereafter control the feeding device to feed the wire electrode backwards at a second speed at least until a second change in the electrical parameter is detected using the electrical parameter measuring device;
thereafter control the feeding device to feed the wire electrode forward at a third speed until a third change in the electrical parameter is detected using the electrical parameter measuring device; and
determine the current position of the wire electrode at least on the basis of a measurement with which the third change in the electrical parameter was detected,
wherein the third speed is preferably lower than the first speed.

8. The welding apparatus according to claim 7, wherein the control device is configured, after determining the current position of the wire electrode, to feed the wire electrode further forward at a fourth speed until the defined free wire electrode length lies between the wire electrode end and the contact tip end.

9. A robotic welding system, comprising:
a welding apparatus according to claim 1,
a robotic device adapted to guide the welding torch of the welding apparatus; and
a system control device which is configured both to generate and transmit control signals for controlling the robotic device and to generate and transmit control signals for controlling the welding apparatus;
wherein the control device of the welding apparatus is configured to receive, among the control signals, a positioning method trigger signal from the system control device, in response to which the control device performs one of the at least one positioning method.

10. The robotic welding system according to claim 9, wherein the positioning method is performed while the robotic device is in transit between two positions at which the welding apparatus is controlled for welding, wherein no welding takes place during the transit.

11. A method for feeding a wire electrode into a position with a defined free wire electrode length from a contact tip of a welding torch of a welding apparatus, comprising:
defining a desired free wire electrode length of the wire electrode;
measuring an electrical parameter between the wire electrode and a reference electrode;
feeding the wire electrode in the direction of a contact tip;
detecting a current position of a wire electrode end of the wire electrode based on a measured change of the measured electrical parameter at an electrical contact between the wire electrode end and the contact tip which is electrically connected to a defined electrical potential while the wire electrode is being fed; and
feeding the wire electrode based on the determined current position and using a known contact tip length of the contact tip until the defined free wire electrode length lies between the wire electrode end and the contact tip end.

12. The method according to claim 11, wherein the reference electrode is electrically connected to ground, and a measuring of the voltage between the wire electrode and ground is performed for measuring the electrical parameter.

13. The method according to claim 12, wherein the reference electrode is electrically connected to a contact tip of the welding torch of the welding apparatus, and a measuring of the voltage between the wire electrode and the contact tip is performed for measuring the electrical parameter.

14. The method according to claim 11, comprising:
detecting a first change in the electrical parameter while the wire electrode is fed forward at a first speed towards the contact tip end;
feeding of the wire electrode at a second speed backwards at least until a second change in the electrical parameter is detected;
feeding the wire electrode forward at a third speed at least until a third change in the electrical parameter is detected; and
determining the current position of the wire electrode end at least based on a measurement with which the third change in the electrical parameter was detected,
wherein the third speed is preferably lower than the first speed.

15. The method according to claim 14, wherein after determining the current position of the wire electrode end, the wire electrode is fed forward at a fourth speed until the defined free wire electrode length lies between the wire electrode end and the contact tip end.
